(19) United States
(12) Patent Application Publication
(10) Pub. No.: US 2008/0087818 A1
(43) Pub. Date: Apr. 17, 2008

(54) ION TRAP MOBILITY SPECTROMETER CALIBRATION METHOD AND SYSTEM

(76) Inventor: Xue-Song Scott Li, Lexington, MA (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/548,544

(22) Filed: Oct. 11, 2006

(51) Int. Cl. H01J 49/00

(52) U.S. Cl. 250/292

(57) ABSTRACT

An ion trap mobility spectrometer calibration system and method wherein the maximum response of the spectrometer is determined. A quantity Q₀ is chosen representing a response which is a predetermined percentage of the maximum response. Input to the ion trap mobility spectrometer are at least two known quantities Q₁ and Q₂ of an analyte, which have a predetermined relationship with Q₀. The responses corresponding to R₁ and R₂ of the ion trap mobility spectrometer are observed based on the respective inputs of quantities Q₁ and Q₂. R₁, R₂, and Q₁ and Q₂ are then used to calculate the calibration constants in an equation describing a curve where the response of the ion trap mobility spectrometer is a function of the quantity of the analyte input therein. The calculated calibration constants are input to thereafter determine, from the response, the quantity of a detected analyte based on the equation.

### FIELD OF THE INVENTION

The subject invention relates to the calibration of analytical instruments.

### BACKGROUND OF THE INVENTION

In the pharmaceutical industry, cleanliness of the drug manufacturing devices and equipment is a concern. Between batches, the Federal Food and Drug Administration (FDA) requires that the equipment used be cleaned to prevent cross-contamination. The cleaning effort must be validated and the analysis used must be accurate to within 15%. It is known to swab the equipment and send the swab to a laboratory for analysis. There, it is common to use a high pressure liquid chromatography (HPLC) system or total organic carbon (TOC), among other techniques, to analyze the swab for contaminants.

The results of the laboratory analysis, however, can take days to receive. Meanwhile, the production line is idle resulting in significant down time costs.

Accordingly, there has been an interest in utilizing smaller portable analyzers which could be located in the manufacturing facility to validate cleanliness. One option is an ion trap mobility spectrometer as set forth, for example, in U.S. Pat. No. 5,491,337 incorporated herein by this reference.

All analytical instruments must generally be calibrated before their output can be deemed reliable. As set forth in U.S. Pat. No. 6,627,444, also incorporated herein by this reference, the working curve calibration method involves the creation of a plot of the response of the instrument as a function of analyte concentration. This plot is obtained by measuring the signal from a series of standards of known concentrations. The working curve may then be used to determine the concentration of an unknown analyte input into the device.

In another method, the relationship between the response of the analytical instrument and the quantity of an analyte input to the instrument is assumed to be linear. At least for ion trap mobility spectrometers, the result of such an assumption can be an inaccuracy greater than 15%, in violation of FDA requirements.

Since the prior ion trap mobility spectrometers were typically used to detect the presence of narcotics or explosives, not their quantity, there are no known accurate and easy to use calibration techniques for an ion trap mobility spectrometer in order to render its use possible in the pharmaceutical industry where typically non-laboratory personnel would be performing the cleanliness analysis and the calibration of the analytical instrument.

### SUMMARY OF THE INVENTION

In one aspect, the subject invention provides a more accurate and yet simple calibration method for an ion trap mobility spectrometer. The calibration method can be easily automated. It can be used in connection with analytical instruments other than ion trap mobility spectrometers and can be used by non-skilled personnel.

The subject invention results from the realization that by using only two calibration points, provided they are chosen to be in a critical response range, the true curvilinear model for an analytical instrument can be determined mathematically resulting in a simpler and more accurate calibration method.

The subject invention, however, in other embodiments, need not achieve all these objectives and the claims hereof should not be limited to structures or methods capable of achieving these objectives.

This invention features an ion trap mobility spectrometer calibration method. The maximum response of the ion trap mobility spectrometer is determined and a quantity Q₀ is chosen representing a response which is a predetermined percentage of the maximum response. At least two known quantities Q₁ and Q₂ of an analyte are input to the ion trap mobility spectrometer. The two known quantities have a predetermined relationship to Q₀. The responses R₁ and R₂ of the ion trap mobility spectrometer are determined based on the respective inputs of quantities Q₁ and Q₂. Using R₁, R₂, and Q₁ and Q₂, the calibration constants are determined in an equation describing a curve where the response of the ion trap mobility spectrometer is a function of the quantity of the analyte input to the ion trap mobility spectrometer. The calculated calibration constants are input to the ion trap mobility spectrometer to thereafter determine, from the response of the ion trap mobility spectrometer, the quantity of a detected analyte based on the equation.

Q₀ may represent a quantity resulting in a response of approximately 70% of the maximum response of the ion trap mobility spectrometer. Q₁ may be approximately ½ Q₀ and Q₂ may be approximately twice Q₀. The preferred equation is the response R=α(1−e^{-βQ}) where α and β are the calibration constants. β may be calculated by an iterative method. α can be calculated once β is determined.

One analytical instrument calibration method includes determining the maximum response of the analytical instrument and choosing a quantity Q₀ representing a response which is a predetermined percentage of the maximum response. Input to the analytical instrument are at least two known quantities Q₁ and Q₂ of an analyte. The two known quantities have a predetermined relationship to Q₀. The corresponding responses R₁ and R₂ of the analytical instrument are determined based on the respective inputs of quantities Q₁ and Q₂. R₁, R₂, and Q₁ and Q₂ are then used to calculate the calibration constants α and β in an equation describing a curve where the response of the analytical instrument is a function of the quantity of the analyte input to the ion trap mobility spectrometer. The calculated calibration constants are input to the analytical instrument to thereafter determine, from the response of the analytical instrument, the quantity of a detected analyte based on the equation.

One analytical instrument calibration method comprises determining the maximum response of the analytical instrument and choosing an analyte quantity Q₀ representing a response which approximately 70% of the maximum response. Input to the analytical instrument are at least two known quantities Q₁ and Q₂ of an analyte where Q₁ is approximately ½ Q₀ and Q₂ is approximately twice Q₀. The corresponding responses R₁ and R₂ of the analytical instrument are then observed based on the respective inputs of quantities Q₁ and Q₂. R₁, R₂, and Q₁ and Q₂ are used to calculate α and β in the equation R=α(1−e^{-βQ}). α and β are then input to an equation thereafter determine, from the response R of the analytical instrument, the quantity Q of a detected analyte based on the equation.

A calibration system for an analytical instrument, in accordance with this invention, features at least two known chosen quantities Q₁ and Q₂ of an analyte each being a predetermined percentage of an analyte quantity Q₀ itself representing a predetermined percentage of the maximum response of the instrument. A processor is configured to receive as an input, the two known quantities of the analyte and the response of the instrument to each known quantity. The processor calculates, based on the input, the calibration constants of the instrument.

### BRIEF DESCRIPTION OF THE SEVERAL VIEWS OF THE DRAWINGS

Other features and advantages will occur to those skilled in the art from the following description and the accompanying drawings, in which:

FIG. 1 is a schematic three-dimensional view showing an example of an ion trap mobility spectrometer which can be calibrated in accordance with the method of the subject invention;

FIG. 2 is a plot showing the response of a typical analytical instrument and how such an instrument is typically calibrated in accordance with the prior art using a number of standards;

FIG. 3 is a plot showing how, in accordance with the prior art, two standard quantities can be used in an analytical instrument calibration process resulting in an erroneous linear relationship between the response of the instrument and the analyte quantity;

FIG. 4 is a flow chart depicting the primary steps associated with one example of a method of calibrating an analytical instrument in accordance with the subject invention;

FIG. 5 is a plot of the response of an analytical instrument versus analyte quantity showing how two calibration points are preferably determined in accordance with the subject invention; and

FIG. 6 is another analytical instrument response plot depicting the result when the analytical instrument is calibrated in accordance with the method and system of the subject invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

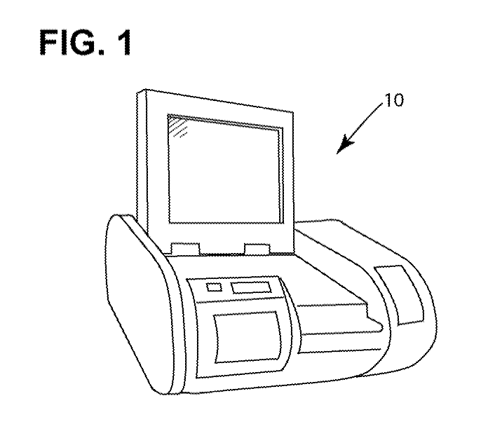

FIG. 1 depicts an ion trap mobility spectrometer instrument 10 (e.g., General Electric Corp.'s “Itemiser³” Dual Mode Detector). An operator swabs a surface of an item and inserts the swab into the instrument which then outputs an indication of whether a contraband is present.

As explained in the Background section above, however, instrument 10, if used in a pharmaceutical industry where the Food and Drug Administration requires validation of cleanliness within a 15% accuracy, must be properly and accurately calibrated.

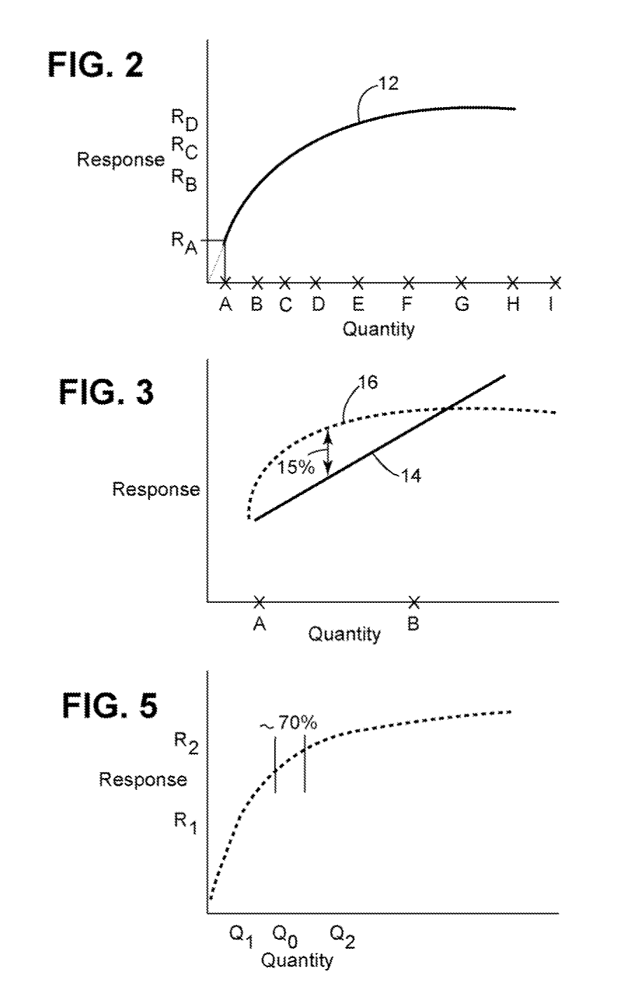

In accordance with the prior art, the working curve calibration method requires numerous standards of a given analyte at different concentrations A-I, FIG. 2. Each standard is input into the instrument and responses R_{A}-R_{I} are observed to construct curve 12 representing the calibrated response of the instrument based on an analyte quantity. Given that standards in liquid form are difficult to handle (see U.S. Pat. No. 6,627,444), may be unstable, and may be hard to use by technicians in the field, the working curve calibration method is highly inefficient especially since numerous standards are required for each analyte of interest.

When only two standards A and B are used, as shown in FIG. 3, for calibration, the calibration process is simpler but the result is a linear relationship 14 between the response of the instrument and the analyte quantity resulting in an error as large as 15% or more from the true response curve of the instrument shown in phantom at 16. This error is unacceptable to the FDA in pharmaceutical cleanliness validation.

The subject invention provides a more accurate and simpler calibration method which can be automated. The method can be used to calibrate ion trap spectrometer 10, FIG. 1 for use in connection with pharmaceutical cleanliness (see U.S. Pat. No. 6,924,477 incorporated herein by this reference). The method can also be used to calibrate ion trap spectrometers for other uses and also to calibrate other analytical instruments for a variety of uses.

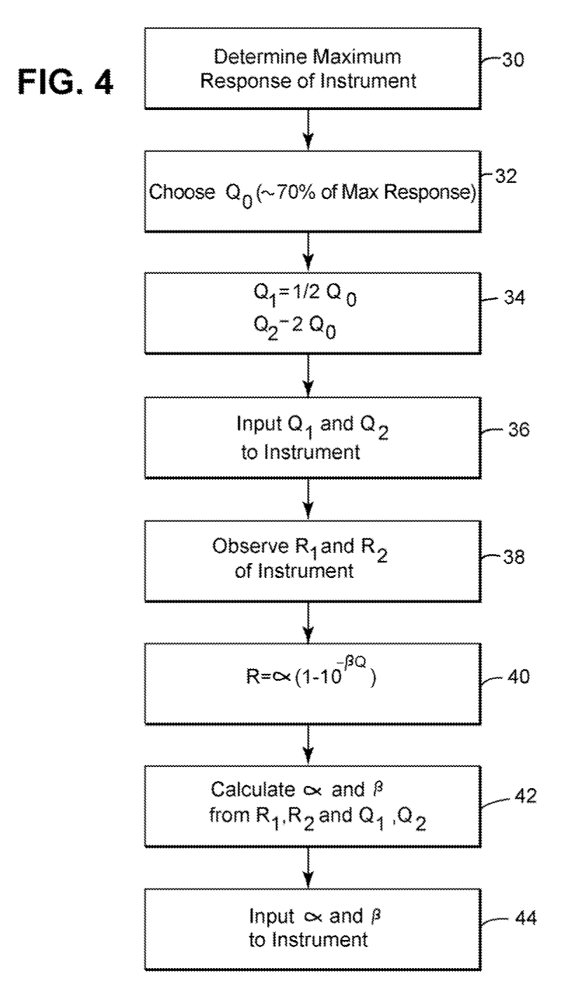

First, the maximum response of the instrument is determined, step 30, FIG. 4. A quantity Q₀ of an analyte which results in a response of approximately 70% of the maximum response of the instrument is then chosen, step 32, FIG. 4. As shown in FIG. 5, known analyte quantities (standards) Q₁ and Q₂ are input into the instrument where, in one preferred example, Q₁≈½Q₀ and Q₂≈2Q₀, steps 34-36, FIG. 4. Other known analyte quantities at other predetermined percentages besides 50% and 200% of Q₀ may be chosen.

The corresponding responses R₁ and R₂ of the instrument are then observed, step 38. A processor is then configured (e.g., programmed) to receive as inputs Q₁, Q₂, R₁, and R₂. The processor, based on these inputs, calculates the two unknowns α and β in equation 1 below, steps 40-42, FIG. 4.

R=α(1−e^{-βQ}) (1)

where R is the response of the instrument to a given quantity Q. Equation 1 represents the true calibration curve of the instrument. As the calibration curve may change over time, calibration constants α and β need to be adjusted and/or checked periodically in order to ensure the accuracy of the measurement.

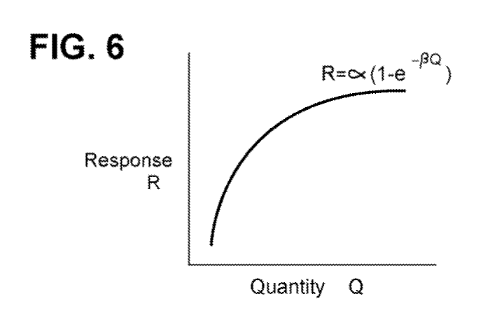

Once α and β are calculated, they are input into the instrument to calibrate it so thereafter the response R of the instrument (see FIG. 6) is a function according to equation (1) based on α, β, and an unknown quantity Q of an analyte, step 44, FIG. 4.

In one preferred version, α and β are calculated by the processor as follows. To determine α and β from the two-point measurement, two equations are used:

$$\begin{matrix}{R}_{1} = α ( 1 - {e}^{- β {Q}_{1}} ) & ( 2 ) \\ {R}_{2} = α ( 1 - {e}^{- β {Q}_{2}} ) & ( 3 )\end{matrix}$$

where Q₁, Q₂, R₁ and R₂ are now known. α and β can then be calculated. The value of α can be obtained once the value of β is known (converges).

To determine the value of β, from the equations (2) and (3) above,

$$\begin{matrix}α - \frac{{R}_{1}}{( 1 - {e}^{- β {Q}_{1}} )} - \frac{{R}_{2}}{( 1 - {e}^{- β {Q}_{2}} )} \\ or & ( 4 ) \\ {R}_{1} ( 1 - {e}^{β {Q}_{2}} ) = {R}_{2} ( 1 - {e}^{- β {Q}_{1}} ) & ( 5 )\end{matrix}$$

New function f(β) is defined as: t,22

f(β)=R₂(1−e^{-βQ}^{₁})−R₁(1−e^{-βQ}^{₂})=0 (6)

The value of β can now be obtained by using Newton's iteration method, that is:

$${β}_{n + 1} = {β}_{n} - \frac{f ( {β}_{n} )}{{f}^{′} ( {β}_{n} )} , \qquad ( 7 )$$

where f′(β) is the first order derivative of f(β):

f′(β)=R₂Q₁e^{-βQ}^{₁}−R₁Q₂e^{βQ}^{₂} (8)

α can then be calculated, once the value of β converges, as:

$$α = \frac{{R}_{1}}{1 - {e}^{- β {Q}_{1}}} . \qquad ( 9 )$$

With values of α and β now calculated, the new calibration curve is determined. A test point was taken to validate the above algorithm resulting in an accuracy better than 1%.

The result is a more accurate calibration method for an ion trap mobility spectrometer or other analytical instrument. The method is simple to use and can be conducted by technicians in the field or on the manufacturing floor. The method can be rendered automatic by the appropriate programming of a computer or even the analytical instrument itself so that, for example, steps 30-34 of FIG. 4 and steps 38-44 are carried out by a processor. All the technician needs to do is provide, when prompted, two standards representing inputs Q₁ and Q₂. Using these two calibration points, provided they are chosen to be in the critical response range discussed above, the true response model for an analytical instrument is determined resulting in a simpler and more accurate calibration method. Errors associated with assuming the response is linear are reduced and the need for numerous standards associated with the working curve calibration method is eliminated. The same process can then be carried out for other analytes of interest.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An ion trap mobility spectrometer calibration method comprising:
determining the maximum response of the ion trap mobility spectrometer and choosing a quantity Q₀ representing a response which is a predetermined percentage of the maximum response;
inputting to the ion trap mobility spectrometer at least two known quantities Q₁ and Q₂ of an analyte, the two known quantities having a predetermined relationship with Q₀;
determining the responses R₁ and R₂ of the ion trap mobility spectrometer based on the respective inputs of quantities Q₁ and Q₂;
using R₁, R₂, and Q₁ and Q₂ to calculate the calibration constants in an equation describing a curve where the response of the ion trap mobility spectrometer is a function of the quantity of the analyte input to the ion trap mobility spectrometer; and
inputting the calculated calibration constants to the ion trap mobility spectrometer to thereafter determine, from the response of the ion trap mobility spectrometer, the quantity of a detected analyte based on the equation.

2. The method of claim 1 in which Q₀ represents a quantity resulting in a response of approximately 70% of the maximum response of the ion trap mobility spectrometer.

3. The method of claim 2 in which Q₁ is approximately ½ Q₀ and Q₂ is approximately twice Q₀.

4. The method of claim 1 in which the equation is Response R=α(1−e^{-βQ}) where α and β are the calibration constants.

5. The method of claim 4 in which β is calculated by an iterative method.

6. The method of claim 5 in which α is calculated once β is calculated.

7. An analytical instrument calibration method comprising:
determining the maximum response of the analytical instrument and choosing a quantity Q₀ representing a response which is a predetermined percentage of the maximum response;
inputting to the analytical instrument at least two known quantities Q₁ and Q₂ of an analyte, the two known quantities having predetermined relationship with Q₀;
determining the responses R₁ and R₂ of the analytical instrument based on the respective inputs of quantities Q₁ and Q₂;
using R₁, R₂, and Q₁ and Q₂ to calculate the calibration constants α and β in an equation describing a curve where the response of the analytical instrument is a function of the quantity of the analyte input to the ion trap mobility spectrometer; and
inputting the calculated calibration constants to the analytical instrument to thereafter determine, from the response of the analytical instrument, the quantity of a detected analyte based on the equation.

8. An analytical instrument calibration method comprising:
determining the maximum response of the analytical instrument and choosing an analyte quantity Q₀ representing a response which approximately 70% of the maximum response;
inputting to the analytical instrument at least two known quantities Q₁ and Q₂ of an analyte where Q₁ is approximately ½ Q₀ and Q₂ is approximately twice Q₀;
determining the responses R₁ and R₂ of the analytical instrument based on the respective inputs of quantities Q₁ and Q₂;
using R₁, R₂, and Q₁ and Q₂ to calculate α and β in the equation R=α(1−e^{-βQ}); and
inputting α and β to the equation to thereafter determine, from the response R of the analytical instrument, the quantity Q of a detected analyte based on the equation.

9. The method of claim 8 in which 13 is calculated by an iterative method.

10. The method of claim 8 in which α is calculated once β is determined.

11. A calibration system for an analytical instrument, the system comprising:
at least two known quantities Q₁ and Q₂ of an analyte each having a predetermined relationship with an analyte quantity Q₀ representing a response of the instrument which is a predetermined percentage of the maximum response of the instrument; and
a processor, configured to:
receive, as an input, the two known quantities of the analyte and the response of the instrument to each known quantity, and
calculating, based on the input, the calibration constants of the instrument.

12. The system of claim 11 in which Q₀ represents an analyte quantity resulting in an instrument response of approximately 70% of the maximum response of the instrument.

13. The system of claim 11 in which Q₁ is approximately ½ Q₀ and Q₂ is approximately twice Q₀.

14. The system of claim 11 in which the response R of the instrument is α(1−e^{-βQ}) where α and β are the calibration constants.

15. The system of claim 14 in which β is calculated by an iterative method.

16. The system of claim 15 in which the α is calculated once β is calculated.
